(19) United States
(12) Patent Application Publication
(10) Pub. No.: US 2025/0142560 A1
(43) Pub. Date: May 1, 2025

(54) NETWORK NODE AND METHOD FOR SCHEDULING USER EQUIPMENTS IN A WIRELESS COMMUNICATIONS NETWORK

(71) Applicant: Telefonaktiebolaget LM Ericsson (publ), Stockholm (SE)

(72) Inventors: Ulf Eric Andretzky, Huddinge (SE); Patrik Karlsson, Sollentuna (SE); Walter Muller, Upplands Vasby (SE)

(21) Appl. No.: 18/835,521

(22) PCT Filed: Feb. 4, 2022
(86) PCT No.: PCT/EP2022/052723

§ 371 Date: Aug. 2, 2024

(51) Int. Cl. H04W 72/1263; H04L 5/00

(52) U.S. Cl. CPC H04W 72/1263; H04L 5/0044

(57) ABSTRACT

A method performed by a network node is provided. The method is for scheduling one or more User Equipments, UEs, in respective upcoming data transmissions in a wireless communications network. The network node schedules (702) a first UE over at least a part of one first cell, for an upcoming first data transmission. The first cell comprises overlapping carrier spectrum to be used by the first cell and enabled to be used by at least one second cell. The first cell is associated with which first cell (11) is associated with a processing resource cost and a radio resource cost for scheduling.

### TECHNICAL FIELD

Embodiments herein relate to a network node and methods therein. In some aspects, they relate to scheduling one or more User Equipments (UEs) in respective upcoming data transmissions in a wireless communications network.

### BACKGROUND

In a typical wireless communication network, wireless devices, also known as wireless communication devices, mobile stations, stations (STA) and/or User Equipments (UE) s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node. The radio network node may be divided into an antenna unit, Radio unit, Distributed unit and Central unit where Distributed unit and Central unit may be realized virtually in a server connected to the radio unit.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are currently being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range, referred to as Millimeter wave (mmWave), have shorter range but higher available bandwidth than bands in the FR1. Other frequency bands are also considered for the future.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may still be beneficial when each UE only has one antenna. Such systems and/or related techniques are commonly referred to as MIMO.

Currently, in a RAN network of a wireless communications network, each Transmission Reception Point (TRP), also referred to herein as network node, is deployed with several cells each one solely covering a part of the capable spectrum at the TRP.

A cell may be without an SSB as well, but is then not detectable to camp at by UE. A cell may transmit, by broadcasting, a Physical Reference Signal (SSB) which enable a UE to detect and identify the best cell to camp on, and when needed, connect to by measuring the SSBs to find the cell with the strongest SSB. Each cell also broadcast system information. The system information provides information to the UE, where in the cell the random access channel is and an applicable configuration to use by the UE for accessing the cell. The system information further provides information to the UE, where in the cell paging is transmitted, if the Mobile system need to contact a UE camping at the cell. The mobile system, often the core network or the RAN, would like to get access and tell RAN to page.

When UEs are connected to the system they are connected to a cell, called primary cell for the connection, other Users can have this cell as secondary cell so it is a connection specific definition. But the UEs may also be configured to be connected to additional multiple cells, called secondary cells for the connection, e.g. by carrier aggregation. The driving reason to this is to increase available Bandwidth (BW) for the user and achieve a good load balancing between cells and higher end-user peak rates, via transmission aggregation from multiple cells to the user.

The scheduling evaluation, decision and configuration in the wireless communications network is performed per cell, where each scheduling decision per cell correspond to a system processing resource cost such as e.g. of one Scheduling Entity per Time Transmission Interval (SE/TTI). An SE/TTI when used herein means the system processing cost of evaluation and scheduling decision of a user per TTI.

So, if one UE is scheduled for a cell it consumes one SE/TTI, two different UEs in the same cell corresponds to two SE/TTI etc. Accordingly, if a single UE is scheduled at two cells it will consume one SE/TTI per cell i.e. in total 2 SE/TTI.

In addition there is an additional radio resource cost for transmitting an indication that something is scheduled. The resource cost may vary depending on link budget and reliability requirements.

Scheduling processing resources and radio resources are critical capacity bottlenecks in the wireless communications network. As the deployed system has an upper limitation in the number of SE/TTI it can process and schedule and may also be limited by the finite amount of radio resources that can be used for this purpose it may result in a capacity limitation that is lower than the capacity limited by other resources. This problem will be further evaluated below.

### SUMMARY

As part of developing embodiments herein, the inventors identified and evaluated a problem which first will be described.

If a network node schedules one UE which can utilize the whole air-interface spectrum of the cell, it will maximize the air-interface capacity by scheduling one UE, i.e. one SE/TTI. However, if instead the scheduled UE does not have so much data to transmit it will not fill up the whole air-interface capacity of the cell, but still consume one SE/TTI. To then be able to utilize all the available air-interface cell capacity the network node needs to be able to schedule 2 SE/TTI i.e. have a higher scheduling processing capacity. This may be extrapolated to a situation where the allocated processing hardware of the network node being part of the wireless communication system solution is able to schedule X number of SE/TTI for a pool of Y cells. Then, depending on the data amount per user that is scheduled, the SE/TTI capacity bottleneck of the system result in different levels of utilization of the total amount of the available air-interface capacity of all these cells. Accordingly, different levels of system capacity.

An object of embodiments herein is to enhance the way of scheduling UEs to improve the performance in a wireless communications network.

According to an aspect of embodiments herein, the object is achieved by a method performed by a network node. The method is for scheduling one or more User Equipments, UEs, in respective upcoming data transmissions in a wireless communications network. The network node schedules a first UE over at least a part of one first cell, for an upcoming first data transmission. The first cell comprises overlapping carrier spectrum to be used by the first cell and enabled to be used by at least one second cell. The first cell is associated with a processing resource cost and a radio resource cost for scheduling.

According to an aspect of embodiments herein, the object is achieved by a network node configured to schedule one or more User Equipments, UEs, in respective upcoming data transmissions in a wireless communications network. The network node is further configured to:
Schedule a first UE over at least a part of one first cell for an upcoming first data transmission, which first cell is adapted to comprise overlapping carrier spectrum to be used by the first cell and enabled to be used by at least one second cell, and which first cell which first cell is adapted to be associated with a processing resource cost and a radio resource cost for scheduling.

Thanks to the overlapping carrier spectrum is used by the first cell and enabled to be used by at least one second cell, the utilization of the available spectrum is more efficiently from a scheduling processing decision perspective. A benefit is that it is possible to consume a lower number of SE/TTI resources when scheduling UEs, e.g. the first UE, with a large amount of data over a wide spectrum. Thereby SE/TTI resources can instead be applied to other UEs, e.g. the second UE, enabling a higher system capacity when it is possible to schedule more UEs.

This an enhanced the way of scheduling UEs to improve the performance in a wireless communications network is achieved.

### BRIEF DESCRIPTION OF THE DRAWINGS

Examples of embodiments herein are described in more detail with reference to attached drawings in which:

FIG. 1 is a schematic block diagram illustrating prior art.

FIGS. 2 a and b are a schematic diagrams illustrating prior art.

FIG. 3 is a diagram illustrating prior art.

FIGS. 4 a and b are schematic diagrams illustrating prior art.

FIGS. 5 a, b and c are schematic diagrams illustrating embodiments herein.

FIG. 6 is a schematic block diagram illustrating embodiments of a wireless communications network.

FIG. 7 is a flowchart depicting an embodiment of a method in a network node.

FIG. 8 is a sequence diagram depicting an embodiment herein.

FIG. 9 is a sequence diagram depicting an embodiment herein.

FIG. 10 a and b are schematic block diagrams illustrating a network node.

FIG. 11 schematically illustrates a telecommunication network connected via an intermediate network to a host computer.

FIG. 12 is a generalized block diagram of a host computer communicating via a base station with a user equipment over a partially wireless connection.

FIGS. 13-16 are flowcharts illustrating methods implemented in a communication system including a host computer, a base station and a user equipment.

### DETAILED DESCRIPTION

As part of developing embodiments herein, the problem identified by the inventors first will be further discussed.

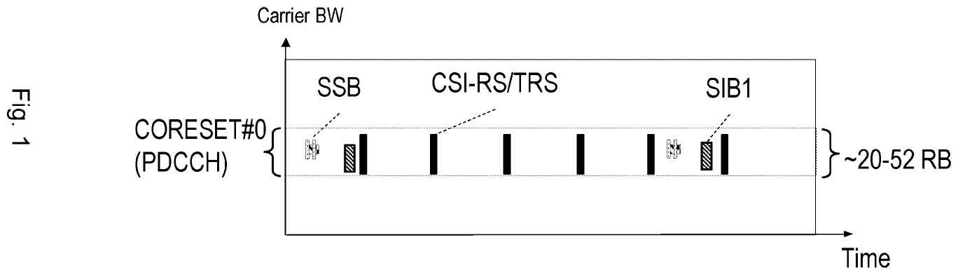

In 5G NR, the existence of a cell is presented to UE's over the air interface by a cell defining SSB reference signal transmission, and a corresponding SIB1 that the SSB reference signal is pointing out. The information from the combined SSB and Master Information Block (MIB) defines a Control-Resource Set (CORESET) where to listen for SIB1 being scheduled and the maximum spectrum allocation, also referred to as a carrier, possible for the cell, see FIG. 1. A CORESET may refer to a set of physical resources, i.e., a specific area on an NR Downlink Resource Grid, and a set of parameters that is used to carry a Physical Downlink Control Channel (PDCCH) Downlink Control Indicator (DCI). FIG. 1 depicts an NR cell and a CORESET #0 of an PDCCH. The CORESET #0 is the CORESET in NR that is defined by the MIB primarily for UEs in IDLE mode. In FIG. 1, the X-axis represents time, and the Y axis represents Carrier Bandwidth (BW). In FIG. 1, the CORESET may e.g. be about 20-52 Resource Blocks (RB) and comprises SSBs, a Channel State Information Reference Signals (CSI-RS)/Tracking Reference Signals (TRS), and an SIB1s.

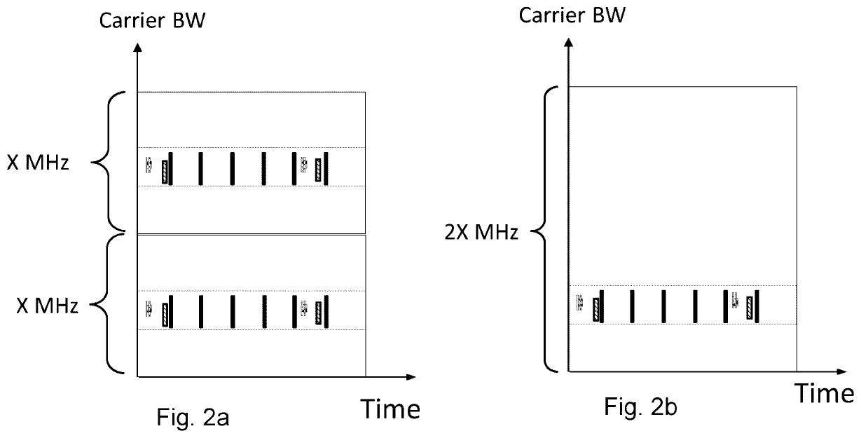

It is important to note that UEs in idle mode only need to consider the CORESET of the cell i.e. a much narrower bandwidth within the carrier of the cell. Within the CORESET all control related capabilities of the cell are allocated, i.e. SSB, System information, paging, initial bandwidth part, PRACH etc., see FIG. 2a and FIG. 2b. FIGS. 2a and 2b each depicts a diagram, wherein in each diagram the X-axis represents time, and the Y axis represents Carrier Bandwidth (BW). The same spectrum can be deployed with one or multiple NR cells, see FIG. 2a wherein two cells of X MHz each are deployed. SSB and SIB1 makes the cell visible UEs in idle mode. See FIG. 2b depicting one cell of 2X MHz visible UEs in idle mode. The Cell carrier in SIB1 defines its maximum spectrum.

This means that for a given spectrum it is possible to define the preferred cell deployment and their capabilities when using this spectrum. Should the spectrum be supported by one cell or two cells, which bandwidth should respective cell have, should the system support one or multiple IDLE UE cell camping capabilities, one or multiple CORESET #0 and thereby one or multiple random-access channels for the spectrum etc. As a result, for a given spectrum the number of cells defined for that spectrum highly influence the system capacity, capability and (IDLE) user handling of that spectrum.

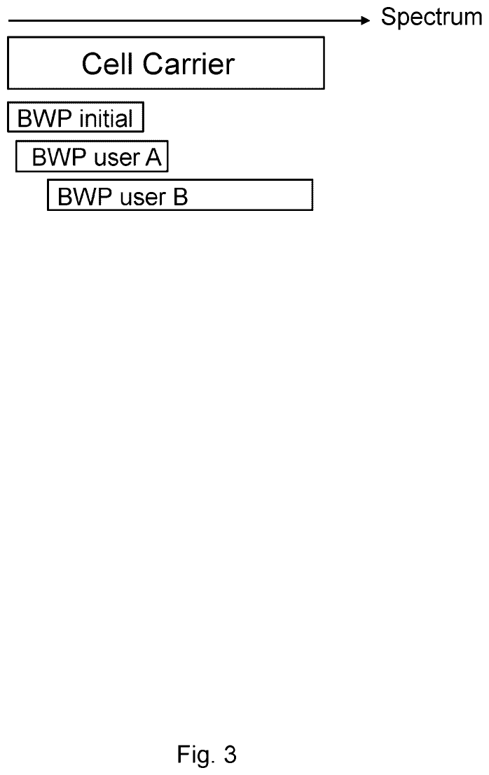

Once a UE is connected to a cell, each UE is individually configured with one or more UE specific bandwidth part(s) (BWP), separate for UL and DL, for each cell. The BWP may be the same for all UEs or specific per UE and may also be dynamically changed, see FIG. 3. FIG. 3 depicts that for a NR Cell Carrier, different UEs (user A, user B in FIG. 3) can have different individual BWPs (BWP user A, BWP user B in FIG. 3) in spectrum. In FIG. 3, the X axis represents the spectrum. BWP initial in FIG. 3 means the initial BWP that is used by the UE before any UE specific BWP configuration has been performed.

Accordingly, a cell with a carrier of 100 MHz and respective 200 MHz will be exactly the same for IDLE UEs i.e. a same CORESET. Also, when a UE is connected to the cells, the cell with a carrier of 100 MHz and respective 200 MHz also looks the same if the BWP of the UE is defined with the same spectrum <100 MHz. However, for a NR cell with carrier of 200 MHz it is possible, not required, to define a UE BWP that supports 200 MHz.

The above describes the basic concepts of an NR cell. The prior art is that this is used as a more capable way of configuring the NR cell and the UEs, but cells are still viewed, limited to, and deployed using orthogonal spectrum resources, see plot in FIG. 2a. There it is only one single cell that has access to a certain spectrum resource at a TRP.

However, it is important to understand that the concept of the NR Cell configuration and handling enables a very different deployment of NR cells. This can according to embodiments herein provide a more efficiency system handling.

There are two important things that should be noted.
Firstly, the cell that is viewed by a UE at IDLE mode is not impacted by the carrier bandwidth capability of the NR cell. IDLE UEs only identify and consider the CORESET of a NR cell, irrespectively of the NR cell's total carrier bandwidth configuration. This is important to note since then the deployment and configuration of how the system IDLE mode UE handling should be is then relative independent or separate from how the cell should be deployed to handle and control its RRC CONNECTED mode users. This provides a deployment and capability freedom in the system.
Secondly, the NR cell carrier configuration is cell specific, and the connected mode BWP is also cell specific for a UE. As a result there is actually nothing that prevents carrier configurations according to embodiments herein of different NR cells from overlapping or partly overlapping the same spectrum, or that the UE specific BWP on respective NR cell is covering or partly covering the same spectrum.

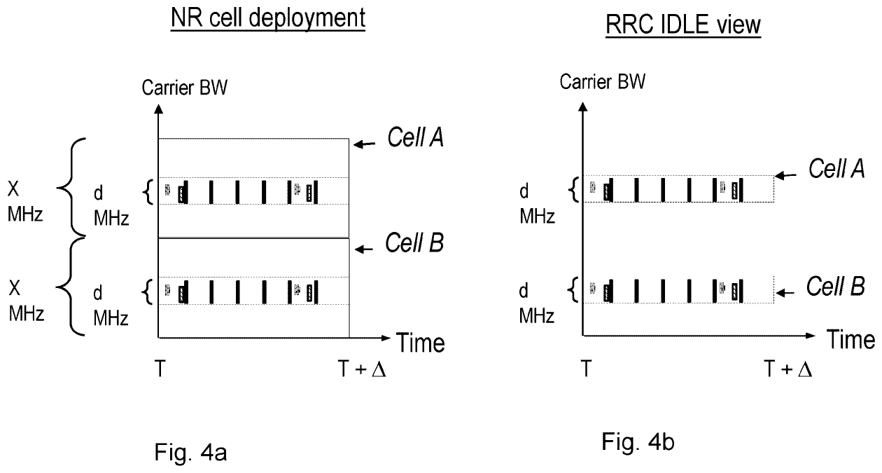

FIG. 4a depicts two NR cells with orthogonal carriers according to prior art and FIG. 4b depicts an IDLE UE view of these cells.

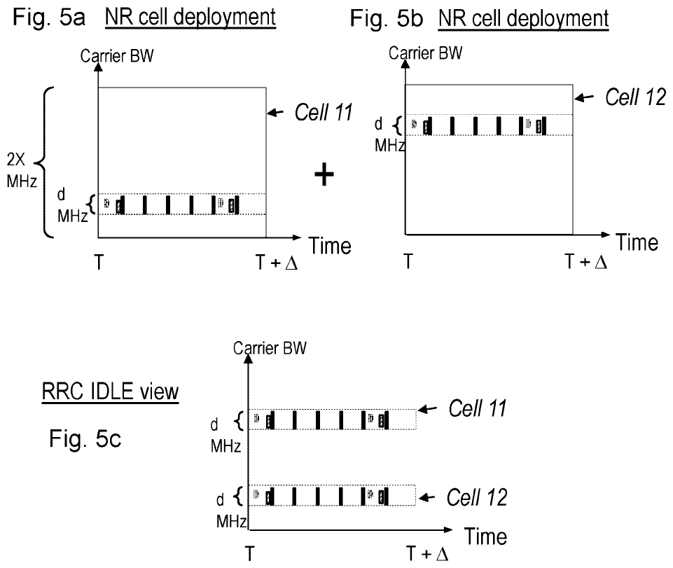

FIG. 5a and FIG. 5b shows two NR cells with overlapping carrier spectrum according to embodiments herein. FIG. 5c shows the IDLE UE view of these cells.

As a result, deploying two NR cells of orthogonal spectrum of 100 MHz according to prior art, see FIG. 4a and FIG. 4b, or two NR cells of 200 MHz according to embodiments herein, see FIG. 5a and FIG. 5b, where their carriers both fully are overlapping but with the same cell specific CORESET configuration as for the 100 MHz deployment, will result in a same cell deployment view from the IDLE UEs perspective. See FIG. 4b and FIG. 5c. Also, same SSB mobility solution will be experienced in the wireless communications network as the SSB deployment is the same for both deployment options.

Thus embodiments herein provide a method performed by a network node wherein a first UE is scheduled over at least a part of one first cell for an upcoming first data transmission. This first cell, e.g. an NR cell, comprises overlapping carrier spectrum to be used by the first cell and enabled to be used by at least one other cell, a second cell. The first cell is associated with only one processing resource cost e.g., of only one first SE/TTI.

It should be noted that a NR cell is defined by the MIB and SIB1 and identified by a SSB identity with a maximum carrier bandwidth capability.

Initially only a bandwidth narrow CORESET is used by the UE for the initial communication with the cell e.g. where to listen for the PDCCH scheduling order

At access, the UE is assigned a UE specific BWP which defines the bandwidth the UE shall utilize for this NR cell.

According to embodiments herein, two NR cells are covering the same or partly the same carrier spectrum. CORESET of respective cell is same as in legacy.

If scheduling a UE over 200 MHz it may be scheduled in one cell and then consumes only one SE/TTI and not two SE/TTI, only a leftover memory note that the SE/TTI is related to the baseband processing capacity.

Cell mobility and camping is unchanged in relation to legacy.

Example embodiments herein relates to scheduling a UE over one cell for an upcoming first data transmission. This one cell comprises overlapping carrier spectrum to be used by this cell and is further enabled to be used by another cell. The scheduled cell is associated with a processing resource cost of only one SE/TTI. This may be referred to as cell spectrum pooling.

Example embodiments may e.g. refer to methods for deploying cells in a RAN to improve the pooling and efficiency of the RAN resources.

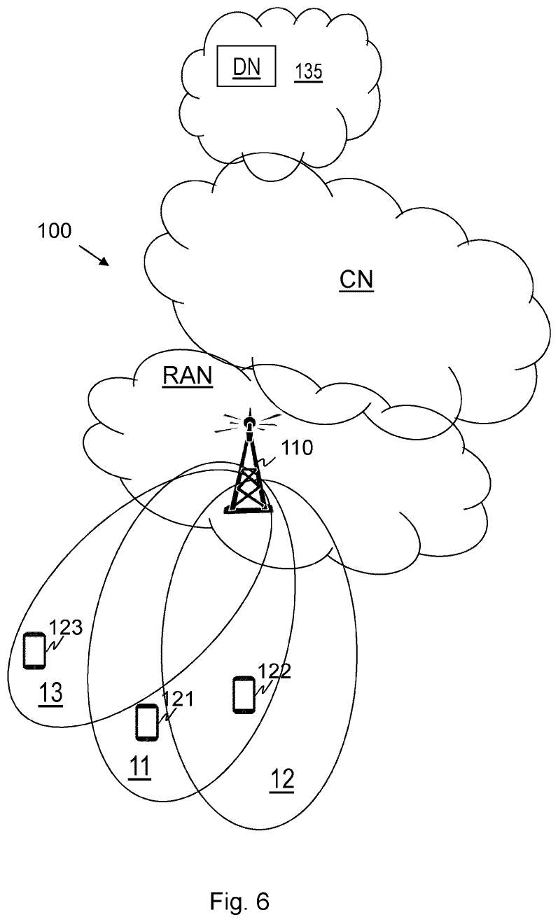

FIG. 6 is a schematic overview depicting a wireless communications network 100 wherein embodiments herein may be implemented. The wireless communications network 100 comprises one or more RANs and one or more CNs. The wireless communications network 100 may use a number of different technologies, such as mmWave communication networks, Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g., a network node 110. The network node 110 provides radio coverage in one or more cells which may also be referred to as a service area, a beam or a beam group of beams, such as e.g. a first cell 11, a second cell 12 and one or more further cells such as one or more third cells 13. It should be noted that only one third cell 13 is shown in FIG. 6.

The network node 110 may be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, an NG-RAN node, a base transceiver station, a radio remote unit, an Access Point Base Station, a base station router, a transmission arrangement of a radio base station, a stand-alone access point or any other network unit capable of communicating with UEs such as e.g. UEs 121, 122, 123, within the respective cells 11, 12, 13 served by the network node 110 depending e.g. on the first radio access technology and terminology used. The network node 110 may communicate with UEs such as the UEs 121, 122, 123, in DL transmissions to the UEs and UL transmissions from the UEs.

A number of UEs operate in the wireless communication network 100, such as e.g. a first UE 121, a second UE 122 and one or more third UE 121. Each of the UEs 121, 122, and 123 may also be referred to as a device, an IoT device, a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g., smart phone, laptop, mobile phone, sensor, relay, mobile tablets or even a small base station communicating within a cell.

The first UE 121 may e.g. be served by the network node 110, in the first cell 11, the second UE 122 may e.g. be served by the network node 110, in the second cell 12, and the third UE 123 may e.g. be served by the network node 110, in the third cell 13. According to examples of embodiments herein, the first cell 11, the second cell 12, and the third cell 13 may be configured with overlapping carrier spectrum. The overlapping carrier spectra of these cells may not be orthogonal spectrum resources in relation to each other.

Methods herein may be performed by the network node 110. As an alternative, a Distributed Node (DN) and functionality, e.g. comprised in a cloud 135 as shown in FIG. 6, may be used for performing or partly performing the methods herein.

For example, an NR RAN cell, e.g. the first cell 11, the second cell 12, and the third cell 13, may only be seen as an identity with related configured functionality. One such cell configuration is the spectrum it supports. Example embodiments herein provide deployment of cells such as the first cell 11, the second cell 12, and the third cell 13, that are capable to overlap each other in a configured spectrum, even when they are deployed on the same TRP spectrum resource, such as a network mode 110 spectrum resource. As cells, such as the first cell 11, the second cell 12, and the third cell 13, then are not limited to be orthogonal in the spectrum configured for different cells, the cells can be configured to cover a wider spectrum. The reason why cells are not limited to be orthogonal in the spectrum configured for different cells is due to that the spectrum of a cell is only a definition of the maximum spectrum that can be used for a user that is connected to that specific cell identification. The utilization of a specific spectrum is not prevented due to users are using different random access configurations, paging channels or listen to different system information, which is aspects defined by the cell via SSB and SIB1. It should be possible to create such different IDLE mode handling in a system without having to fragment the utilization of the scares spectrum resource for the dedicated user data transmissions. A wider cell spectrum enables that a UE, such as e.g. the first UE 121, when having a large amount of data that should be scheduled over a wide spectrum, may be scheduled in one cell and only consume one SE/TTI resource, instead of consuming multiple SE/TTI if scheduled in multiple cells via carrier aggregation over the same spectrum. The overlapping carrier spectrum such as e.g. overlapping cell deployment aspect according to embodiments herein, still secures that the same number of cells is maintained in the system to not impact IDLE camping, mobility, and load distribution etc.

An example of a benefit of embodiments herein, is that it is possible to consume a lower number of SE/TTI resources when scheduling UEs such as the first UE 121, with a large amount of data over a wide spectrum. Thereby SE/TTI resources can instead be applied to other UEs, such as the second and/or third UEs 122, 123, enable a higher system capacity when possible, to schedule more UEs.

A number of embodiments will now be described, some of which may be seen as alternatives, while some may be used in combination.

The term carrier when used herein means the spectrum which is defined to be possible to use for users connected to a cell

The terms spectrum and carrier spectrum when used herein means a frequency bandwidth in MHz, which is possible to define as a carrier to a cell.

The term overlapping carrier spectrum when used herein means a frequency bandwidth in MHz, which can be used by multiple carriers and/or cells.

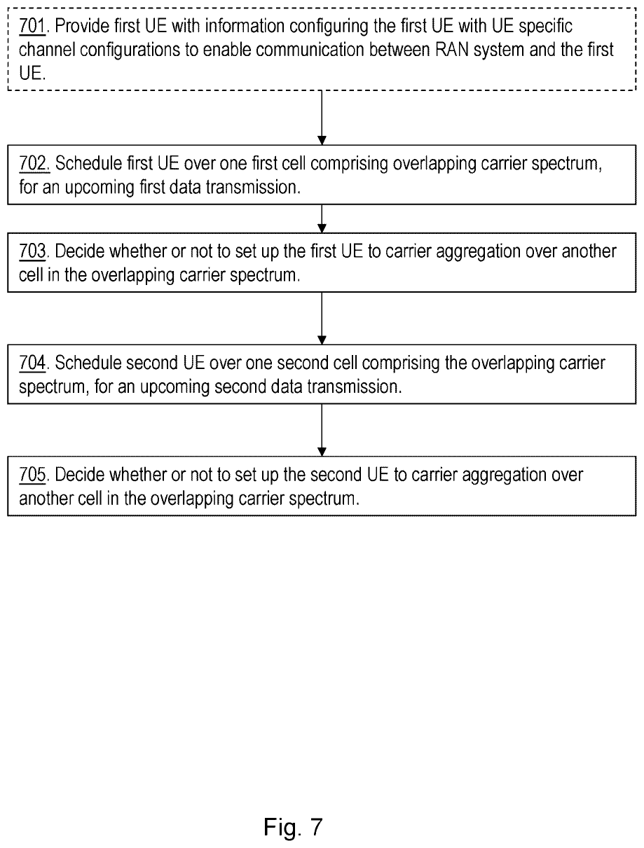

FIG. 7 shows example embodiments of a method performed by the network node 110. The method is for scheduling one or more User Equipments, UEs, 121, 122, 123 in respective upcoming data transmissions in a wireless communications network 100.

The method comprises the following actions, which actions may be taken in any suitable order. Optional actions are referred to as dashed boxes in FIG. 7.

### Action 701

The network node 110 may provide information to the first UE 121 and possibly to the second UE 122. This information configures first the UE 121, and possibly the second UE 122, with the UE specific channel configurations to enable communication between the RAN system and the first UE 121 and possible second UE 122, e.g., BWP, scrambling identities, reference signals etc.

### Action 702

The network node 110 schedules the first UE 121 over at least a part of one first cell 11 for an upcoming first data transmission. This means that the first UE 121 may be scheduled over the complete first cell spectrum or only over a part of the first cell 11 spectrum.

The first cell 11 comprises overlapping carrier spectrum. To use overlapping carrier spectrum is an advantage since it does not fragment the spectrum resource, to be limited to only be used by users connected to one specific cell. The overlapping carrier spectrum is to be used by the first cell 11 and is enabled to be used by at least one second cell 12. This e.g., means that a carrier spectrum used by the first cell 11 overlaps a carrier spectrum used by the second cell 12. This is possible in embodiments herein since each cell has its own defined carrier that defines the spectrum it is possible to use. Independently of if that spectrum is possible to use by others.

Each scheduling in the first cell 11 is associated with a processing resource cost and a radio resource cost for scheduling. A large number of different scheduling decisions increase the processing resource cost, and a few numbers of different scheduling decisions have a lower processing resource cost. To be able to use a few numbers of scheduling decisions is an advantage as it consumes a lower processing resource cost of the system. Accordingly. it is advantageous to be able to schedule a user with one scheduling decision over a very wide spectrum. This means that the first UE 121 need only to consume one processing resource cost, e.g., SE/TTI. The first cell 11 may be associated to one PDCCH.

The first cell 11 and the second and third cells 12, 13 may each comprise much wider carrier spectrum, e.g. twice as wide carrier spectrum, as a normal legacy cell. A normal legacy cell may comprise 100 kHz carrier spectrum where the first and second cells 11, 12 according to embodiments herein comprises 200 KHz carrier spectrum. This is possible since each cell has its own defined carrier that defines the spectrum it is possible to use. Independently of if that spectrum is possible to use by others.

According to an example scenario, the first UE 121 supports a 200 kHz cell and requires 200 kHz cell spectrum for its upcoming transmission. Instead of scheduling two 100 kHz cells resulting in twice processing resource costs according to prior art, the network node 110 schedules the first cell, in this example one 200 kHz cell, with only one processing resource cost. This first cell, in this example one 200 kHz cell, comprises overlapping carrier spectrum that may be used by the second cell.

The overlapping carrier spectrum may be used by any one or more out of: the first UE 121 in the first cell 11, the second UE 122 in the second cell 12, and by one or more third UEs 123 in a respective third cell 13.

The overlapping carrier spectra of any of the respective first cell 11, second cell 12, and third cells 13, are not orthogonal spectrum resources in relation to each other. This is since each cell has its own defined carrier that defines the spectrum it is possible to use. Independently of if that spectrum is possible to use by others. Thereby multiple cells can access the same overlapping spectrum. The advantage of this is that each cell can cover a larger spectrum bandwidth and it is possible to schedule users over a larger spectrum with one single scheduling decision. Thereby scheduling will consume less of the system capacity limited processing resources, as that cost is related to the number of scheduling decisions and not the size of the spectrum used by the scheduling decision.

### Action 703

The first UE 121 may still be configured with carrier aggregation of two or more overlapping cells, such as the first cell 11 and e.g. the second cell 12 even if they share the same spectrum. The network node 110 may decide whether or not to set up the first UE 121 to carrier aggregation over another cell in the overlapping carrier spectrum.

### Action 704

The network node 110 may then schedule the second UE 122 over at least a part of one second cell 12 for an upcoming second data transmission. This means also that the second UE 122 may be scheduled over the complete first cell spectrum or only over a part of the second cell 12 spectrum. The second cell 12 comprises the overlapping carrier spectrum to be used by the second cell 12 and by at least the first cell 11. Each scheduling in the second cell 12 is associated with a processing resource cost and a radio resource cost for scheduling The second cell 12 may be associated to one second SE/TTI scheduling resource cost. The second cell 12 may further be associated to one PDCCH.

As mentioned above, the overlapping carrier spectrum may be used by any one or more out of: the first UE 121 in the first cell 11, the second UE 122 in the second cell 12, and by one or more third UEs 123 in a respective third cell 13.

As mentioned above, the overlapping carrier spectra of any of the respective first cell 11, second cell 12, and third cells 13, are not orthogonal spectrum resources in relation to each other.

### Action 705

Also the second UE 122 may be configured with carrier aggregation of two or more overlapping cells, such as the first cell 11 and the second cell 12 even if they share the same spectrum. The network node 110 may decide whether or not to set up the second UE 122 to carrier aggregation over another cell in the overlapping carrier spectrum.

By using embodiments of the method described above, it is possible to schedule two or more UEs such as the first UE 121 and the second UE 122 in cells where their respective carrier spectrum overlaps each other. This is an advantage since the spectrum usage is not fragmented to single cells, and thereby it is possible to schedule users with one scheduling decision over a larger spectrum and thereby consuming less of the capacity limiting processing resource cost

The above embodiments will now be further explained and exemplified below. The embodiments below may be combined with any suitable embodiment above.

Referring again to FIG. 5a and FIG. 5b showing two NR cells the first cell 11 in FIG. 5a and the second cell 12 in FIG. 5b, with overlapping carrier spectrum according to embodiments herein. The two cells are configured with 2× MHz, e.g. 200 kHz each. FIG. 5c showing the IDLE UE view of these two cells 11 and 12.

According to embodiments herein, with a cell, such as e.g. the first cell 11, with a 200 MHz carrier it is possible to configure UEs such as the first UE 121 connected to this cell with a BWP of 200 MHz, instead of two 100 KHz cells. This enables the network node 110 to schedule a UE such as the first UE 121 over 200 MHz from one cell, the first cell 11, resulting in only one SE/TTI and e.g. with one PDCCH. It is also possible to schedule these UEs such as the first UE 121 over at least a part of the first cell 11, e.g. in a narrower bandwidth transmission for any part of the 200 MHz carrier.

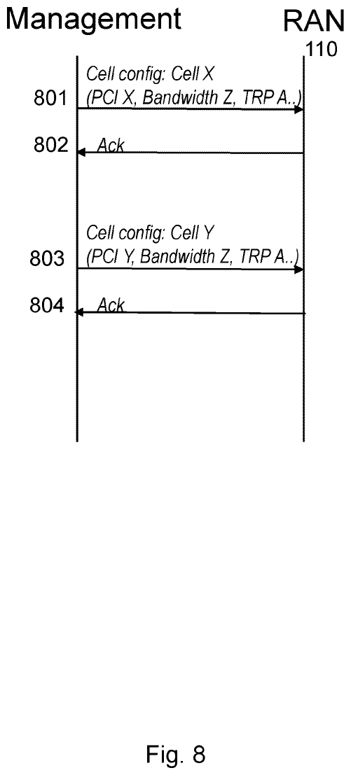

FIG. 8 describes some embodiments, the configuration of the RAN. This does not provide any higher rate or load balancing, but may add the reliability achieved by enabling multiple control planes with SSB, CQI reporting, PUCCH etc. FIG. 8 shows a simplified signaling diagram of configuration of a Cell X, e.g. the first cell 11 respective a Cell Y, e.g. the second cell 12, with same spectrum bandwidth Z at the same TRP resource A of the network node 110.

The Management system of RAN, where the configuration and/or deployment of RAN is controlled sends 801 the cell configuration of Cell X, e.g. the first cell 11, to the network node 110 in the RAN. The cell configuration of Cell X comprises a PCI X, the bandwidth Y, and TRP A. The network node 110 in the RAN acknowledges 802 the Cell X configuration to the Management

The Management system sends 803 the cell configuration of Cell Y, e.g. the second cell 12, to the network node 110 in the RAN. The cell configuration of Cell Y comprises a PCI Y, the bandwidth Y, and TRP A. The network node 110 in the RAN acknowledges 804 the Cell Y configuration to the Management

A UE such as the first UE 121 or second UE 122, may still be scheduled with carrier aggregation from the two cells where respective cell transmit over 100 MHz orthogonal bandwidth and consuming 2 SE/TTI, in the same way as it would be limited to if the two cells where only configured with 100 MHz each. Thus embodiments herein are not prevented from scheduling in the prior art way, it is still within the scope of using overlapping cells according to embodiments herein.

Embodiments herein providing overlapping cells, e.g., NR cells, that is overlapping carrier spectrum, enables an improved spectrum resource pooling utilization of the available spectrum. This is since it is possible to utilize the whole spectrum with a lower SE/TTI resource consumption, as it is possible to schedule a UE over the whole spectrum using only one SE/TTI. This is possible without compromising other aspects like system reliability as the number of cells can remain unchanged. Spectrum resource pooling utilization e.g., means that the spectrum resource is shared and controlled by multiple cells

The carrier spectrum may be utilized more efficiently from a scheduling processing decision perspective, as the full spectrum may be used with one DPCCH transmission and one SE/TTI scheduling resource cost if the network node 110 such as one of its schedulers is applied for the spectrum, in relation to a legacy cost of two SE/TTI if the NR cells instead has a narrower and orthogonal bandwidth.

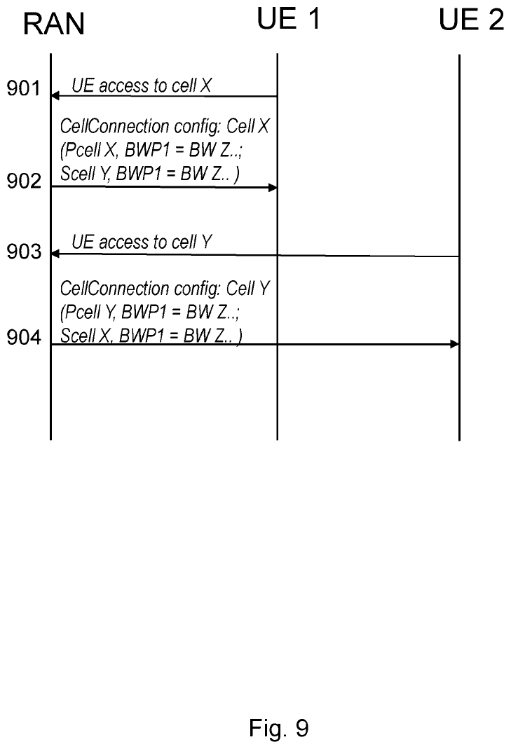

FIG. 9 shows a signaling diagram of two UEs, the first UE 121 and the second UE 122 accessing two different NR cells, the first cell 121, referred to as PCell X and the second cell 122, referred to as PCell Y, being configured with carrier aggregation of two spectrum overlapping cells.

The first UE 121 is referred to as UE 1, and the second UE 122 is referred to as UE 2 in FIG. 9. The network node 110 is referred to as RAN in FIG. 9.

The first UE 121 accesses 901 to cell X. The RAN then sends 902 a cell connection configuration to the first UE 121.

The connection is configured with a Pcell X comprising a bandwidth part 1 (BWP1) being equal to BW Z (Z=bandwidth not BWP, the signaling diagram is showing that all BWPs are assigned the same bandwidth (BW)). The connection is further configured with a Scell Y comprising a BWP1 being equal to BW Z. This means that the two BWP of the two cells in the connection of UE 1 are assigned the same overlapping bandwidth Z

The second UE 122 accesses 903 to cell Y. The RAN then sends 904 a cell connection configuration of cell Y to the second UE 122.

The connection is configured with a Pcell Y comprising a bandwidth part 1 (BWP1) being equal to BW Z. The connection is further configured with a Scell X comprising a BWP1 being equal to BW Z. This means that the two BWP of the two cells in the connection of UE 2 are assigned the same overlapping bandwidth Z. This further means that the two UEs have different Pcells and SCells. But both UEs are connected to the same two cells (X & Y) with same overlapping bandwidth Z from there two cells.

According to embodiments herein, cells, e.g. NR cells such as the first cell 11, the second cell 12 and the one or more third cells 13, are possible to be deployed with overlapping carrier spectrum on the same TRP spectrum resource provided by the network node 110.

The UEs 121, 122, 123 may be connected via carrier aggregation to multiple cells such as the first cell 11, the second cell 12 and the one or more third cells 13, which have overlapping spectrum.

The UEs 121, 122, 123 may each be configured in one respective cell with bandwidth parts of different cells which overlap in spectrum.

The network node 110 is able to schedule UE specific transmissions from any cell, e.g. NR cell, for which the respective UE 121, 122, 123 has a BWP configured that cover that spectrum.

To perform the method actions above, the network node 110 is configured to schedule the one or more User Equipments, UEs, 121, 122, 123 in respective upcoming data transmissions in the wireless communications network 100.

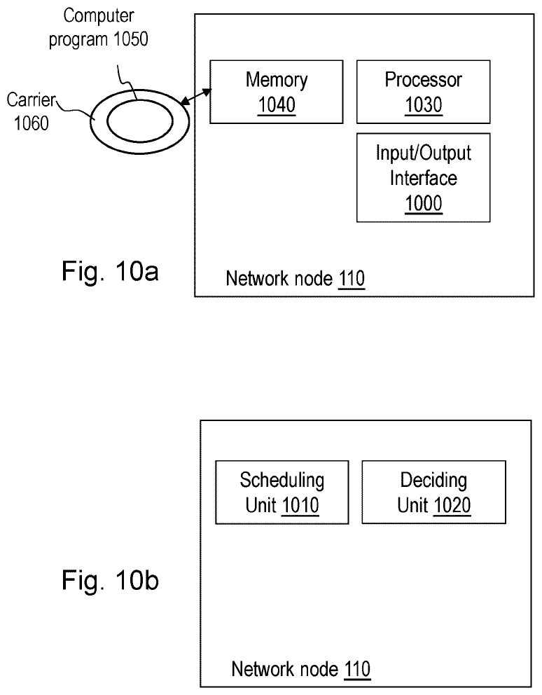

The network node 110 may comprise an arrangement depicted in FIGS. 10a and 10b.

The network node 110 may comprise an input and output interface 1000 configured to communicate with UEs such as e.g., the UEs 121, 122, 123, and with other network nodes in the wireless communications network 100. The input and output interface 1000 may comprise a wireless receiver (not shown) and a wireless transmitter (not shown).

The network node 110 is further configured to, e.g. by means of a scheduling unit 1010 in the first network node 111, schedule the first UE 121 over at least a part of one first cell 11 for an upcoming first data transmission. The first cell 11 is adapted to comprise overlapping carrier spectrum to be used by the first cell 11 and enabled to be used by at least one second cell 12. Further, each scheduling in the first cell 11 is associated with a processing resource cost and a radio resource cost for scheduling.

The first cell 11 may be adapted to be associated to one PDCCH.

The network node 110 is further configured to, e.g. by means of the scheduling unit 1010 in the first network node 111, schedule the second UE 122 over at least a part of one second cell 12 for an upcoming second data transmission. The second cell 12 is adapted to comprises the overlapping carrier spectrum to be used by the second cell 12 and by at least the first cell 11. Further, each scheduling in the second cell 12 is associated with a processing resource cost and a radio resource cost for scheduling.

The second cell 12 may be adapted to be associated to one PDCCH.

The overlapping carrier spectrum may be adapted to be used by any one or more out of: the first UE 121 in the first cell 11, the second UE 122 in the second cell 12, and by the one or more third UEs 123 in the respective third cell 13.

The overlapping carrier spectra of any of the respective first cell 11, second cell 12, and third cells 13, may be adapted to be not orthogonal spectrum resources in relation to each other.

The network node 110 may further be configured to, e.g. by means of a deciding unit 1020 in the first network node 111:

Decide whether or not to set up the first UE 121 to carrier aggregation over another cell in the overlapping carrier spectrum, and/or decide whether or not to set up the second UE 122 to carrier aggregation over another cell in the overlapping carrier spectrum.

The embodiments herein may be implemented through a respective processor or one or more processors, such as the processor 1030 of a processing circuitry in the network node 110 depicted in FIG. 10a, together with computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to either of the network node 110.

The network node 110 may further comprise a memory 1040 comprising one or more memory units. The memory 1040 comprises instructions executable by the processor in the network node 110. The memory 1040 is arranged to be used to store e.g. information, indications, symbols, data, configurations, and applications to perform the methods herein when being executed in the network node 110.

In some embodiments, a computer program 1050 comprises instructions, which when executed by the at least one processor 1030, cause the at least one processor 1030 of the network node 110 to perform the actions above.

In some embodiments, a carrier 1060 comprises the computer program 1050, wherein the carrier 1060 is one of an electronic signal, an optical signal, an electromagnetic signal, a magnetic signal, an electric signal, a radio signal, a microwave signal, or a computer-readable storage medium.

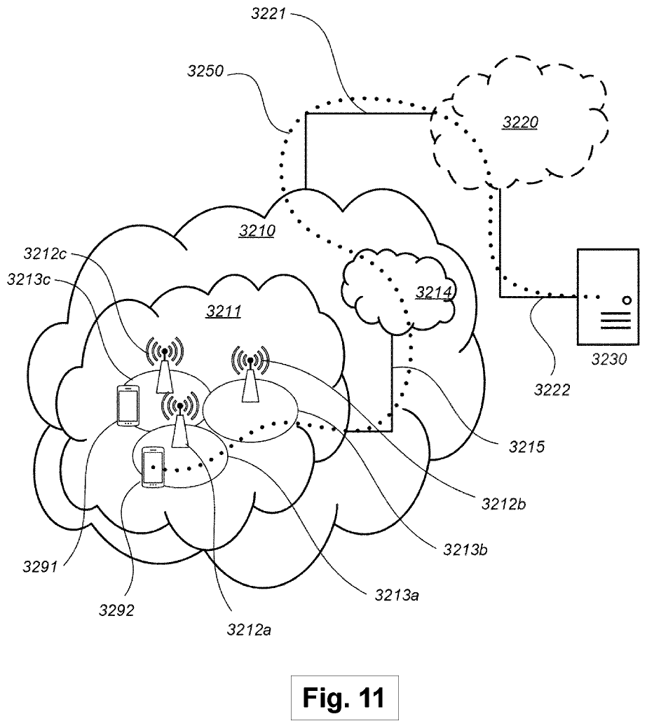

With reference to FIG. 11, in accordance with an embodiment, a communication system includes a telecommunication network 3210, such as a 3GPP-type cellular network, e.g. the wireless communications network 100, which comprises an access network 3211, such as a radio access network, and a core network 3214. The access network 3211 comprises a plurality of base stations 3212a, 3212b, 3212c, e.g. the network node 110, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291, e.g. the UEs 121, 122, 123, located in coverage area 3213c is configured to wirelessly connect to, or be paged by, the corresponding base station 3212c. A second UE 3292 e.g. the UE 122, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 11 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

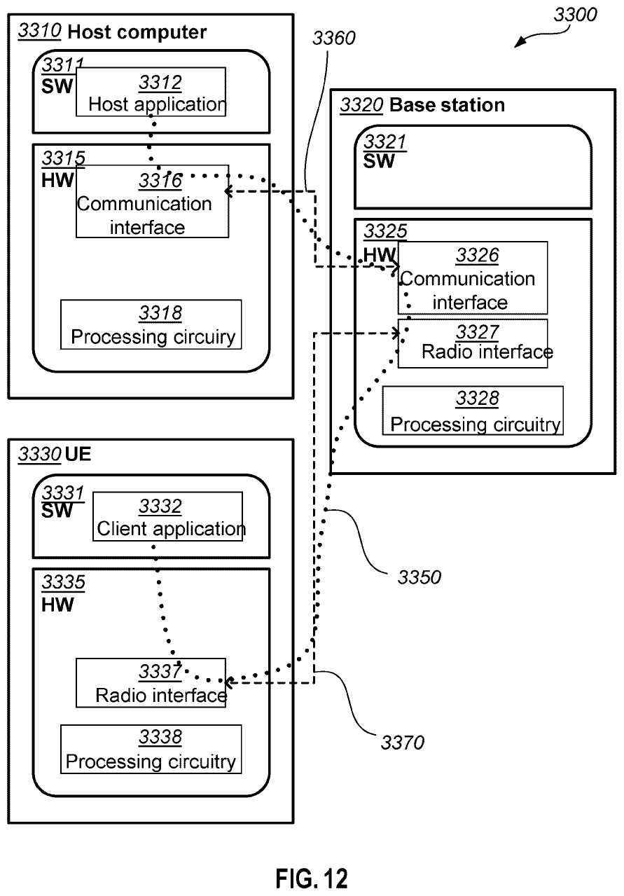

Example implementations, in accordance with an embodiment, of the UE, base station and host computer discussed in the preceding paragraphs will now be described with reference to FIG. 12. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 12 may be identical to the host computer 3230, one of the base stations 3212a, 3212b, 3212c and one of the UEs 3291, 3292 of FIG. 11, respectively. This is to say, the inner workings of these entities may be as shown in FIG. 12 and independently, the surrounding network topology may be that of FIG. 11.

In FIG. 12, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

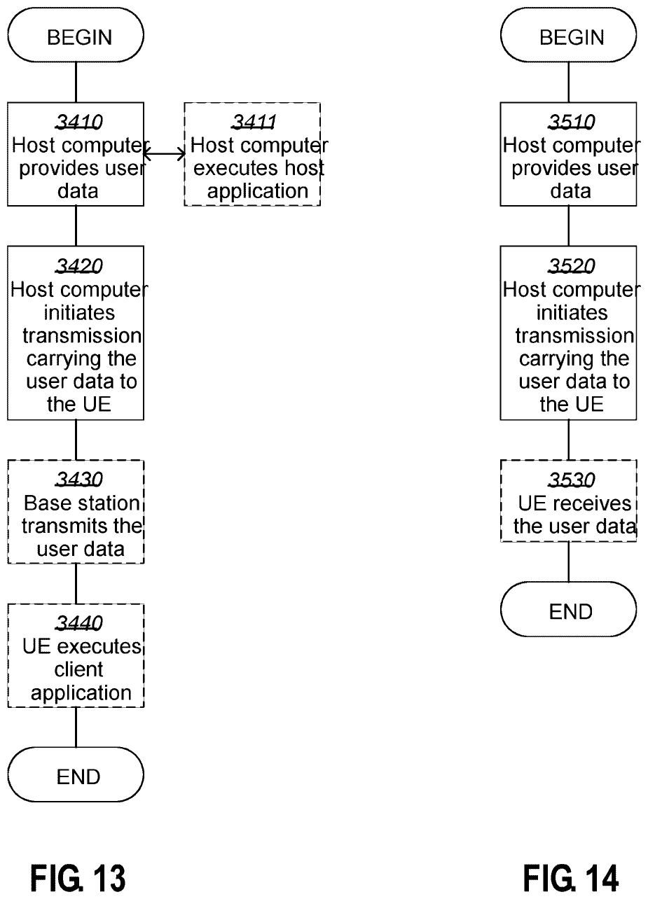

FIG. 13 is a flowchart illustrating a method implemented in a communication system, in accordance with one embodiment. The communication system includes a host computer, a base station such as a AP STA, and a UE such as a Non-AP STA which may be those described with reference to FIG. 11 and FIG. 12. For simplicity of the present disclosure, only drawing references to FIG. 13 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 11 and FIG. 12. For simplicity of the present disclosure, only drawing references to FIG. 14 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

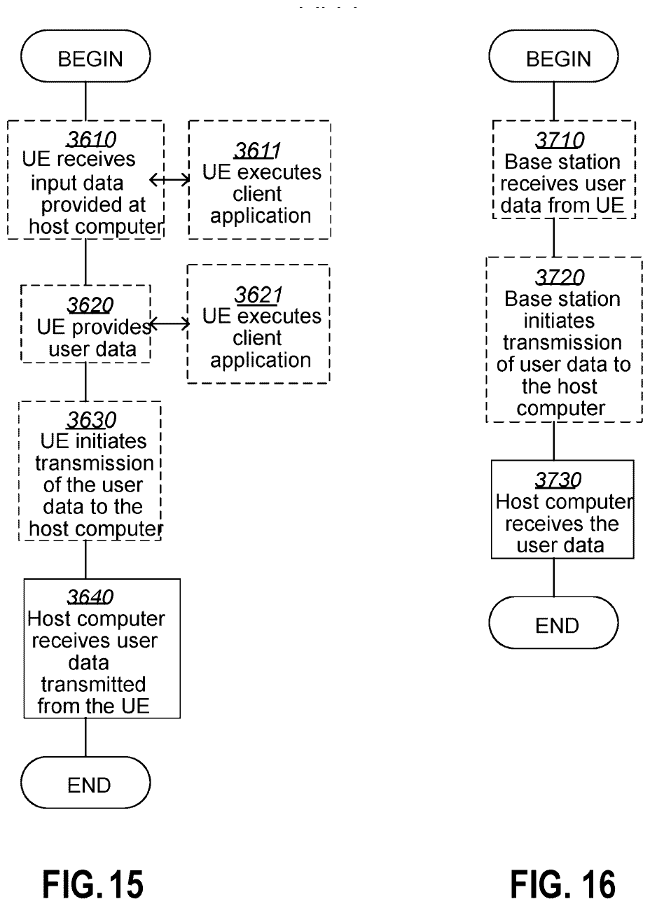

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 12. For simplicity of the present disclosure, only drawing references to FIG. 15 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station such as a AP STA, and a UE such as a Non-AP STA which may be those described with reference to FIG. 15 and FIG. 16. For simplicity of the present disclosure, only drawing references to FIG. 16 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### ABBREVIATION EXPLANATION

BWP Bandwidth Part
PDCCH Physical Downlink Control Channel
PRACH Physical Random Access Channel
PUCCH Physical Uplink Control Channel
SE Scheduling Entity
SIB System Information Broadcast
SSB Synchronization Signal Block
TRP Transmission Reception Point
Time Transmission Interval TTI

1. A method performed by a network node (110), for scheduling one or more User Equipments, UEs, (121, 122, 123) in respective upcoming data transmissions in a wireless communications network (100), the method comprising:
scheduling (702) a first UE (121) over at least a part of one first cell (11), for an upcoming first data transmission,
which first cell (11) comprises overlapping carrier spectrum to be used by the first cell (11) and enabled to be used by at least one second cell (12), wherein the overlapping carrier spectrum to be used by the first cell and the at least one second cell are controlled by the same network node (110), and wherein each scheduling in the first cell (11) is associated with a processing resource cost and a radio resource cost for scheduling.

2. The method according to claim 1, further comprising:
scheduling (704) a second UE (122) over at least a part of one second cell (12), for an upcoming second data transmission,
which second cell (12) comprises the overlapping carrier spectrum to be used by the second cell (12) and by at least the first cell (11), and wherein each scheduling in the second cell (12) is associated to a processing resource cost and a radio resource cost for scheduling.

3. The method according to claim 1, wherein:
the first cell (11) is associated to one Physical Downlink Control Channel, PDCCH, and/or the second cell (12) is associated to one PDCCH.

4. The method according to claim 1, wherein the overlapping carrier spectrum is used by any one or more out of: the first UE (121) in the first cell (11), the second UE (122) in the second cell (12), and by one or more third UEs (123) in a respective third cell (13).

5. The method according to claim 1, wherein the overlapping carrier spectra of any of the respective first cell (11), second cell (12), and third cells (13), are not orthogonal spectrum resources in relation to each other.

6. The method according to claim 1, further comprising:
deciding (703) whether or not to set up the first UE (121) to carrier aggregation over another cell in the overlapping carrier spectrum, and/or
deciding (705) whether or not to set up the second UE (122) to carrier aggregation over another cell in the overlapping carrier spectrum.

7. A computer program (1050) comprising instructions, which when executed by a processor (1030), causes the processor (1030) to perform actions according to claim 1.

8. A carrier (1060) comprising the computer program (1050) of claim 7, wherein the carrier (1060) is one of an electronic signal, an optical signal, an electromagnetic signal, a magnetic signal, an electric signal, a radio signal, a microwave signal, or a computer-readable storage medium.

9. A network node (110) configured to schedule one or more User Equipments, UEs, (121, 122, 123) in respective upcoming data transmissions in a wireless communications network (100), the network node (110) further being configured to:
schedule a first UE (121) over at least a part of one first cell (11) for an upcoming first data transmission,
which first cell (11) is adapted to comprise overlapping carrier spectrum to be used by the first cell (11) and enabled to be used by at least one second cell (12),
wherein the overlapping carrier spectrum to be used by the first cell and the at least one second cell are controlled by the same network node (110), and wherein each scheduling in the first cell (11) is adapted to be associated with a processing resource cost and a radio resource cost for scheduling.

10. The network node (110) according to claim 9, further being configured to:
schedule a second UE (122) over at least a part of one second cell (12) for an upcoming second data transmission,
which second cell (12) is adapted to comprises the overlapping carrier spectrum to be used by the second cell (12) and by at least the first cell (11), and wherein each scheduling in the second cell (12) is adapted to be associated with a processing resource cost and a radio resource cost for scheduling.

11. The network node (110) according to claim 9, wherein:
the first cell (11) is adapted to be associated to one Physical Downlink Control Channel, PDCCH, and/or
the second cell (12) is adapted to be associated to one PDCCH.

12. The network node (110) according to claim 9, wherein the overlapping carrier spectrum is adapted to be used by any one or more out of: the first UE (121) in the first cell (11), the second UE (122) in the second cell (12), and by one or more third UEs (123) in a respective third cell (13).

13. The network node (110) according to claim 9, wherein the overlapping carrier spectra of any of the respective first cell (11), second cell (12), and third cells (13), are adapted to be not orthogonal spectrum resources in relation to each other.

14. The network node (110) according to claim 9, further being configured to:
decide whether or not to set up the first UE (121) to carrier aggregation over another cell in the overlapping carrier spectrum, and/or
decide whether or not to set up the second UE (122) to carrier aggregation over another cell in the overlapping carrier spectrum.
